(19) United States
(12) Patent Application Publication
(10) Pub. No.: US 2003/0157985 A1
(43) Pub. Date: Aug. 21, 2003

(54) Virtual IPR system in electronic game environment

(75) Inventor: Yevgeniy Eugene Shteyn, Cupertino, CA (US)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/080,065

(22) Filed: Feb. 19, 2002

(51) Int. Cl. G06F 17/00

(52) U.S. Cl. 463/42

(57) ABSTRACT

A player who comes up with an innovative strategy in an electronic game is given benefits in the game environment and/or in the players' community because of creating this strategy. This extra dimension stimulates the involvement of the players and contributes to the evolution of the game.

### FIELD OF THE INVENTION

The invention relates to the field of networked virtual environments, in particular to on-line computer gaming and interactive systems.

### BACKGROUND ART AND SUMMARY OF THE INVENTION

On-line computer gaming is known. A number of Internet-based gaming portals, e.g., http://games.yahoo.com, offer multi-player games, tournaments, etc. The aforementioned yahoo web server indicated that on Friday Dec. 14, 2001, 78239 players were involved in a wide variety of games in multiple categories. Using an HTML browser, an individual or a team can select and then participate in a particular game or a tournament, e.g., with a particular opponent, earn points, ratings and other types of rewards reflecting their skill and ingenuity. Players are required to register with the site. Their game actions may be monitored and recorded. Similar sites specializing in a certain game category, e.g., action, strategy, board, etc., are also known. Consider http://www.strategy-gaming.com/—a strategy oriented web site that provides information, strategy guides, reviews and other services to the gaming community. A number of PC games, e.g., DOOM, also enable the user to play against the computer or against other players via a network, e.g., LAN, WAN. In another example “Motor City online” at http://mco.ea.com/main.html enables a PC user with an Internet connection to participate in a virtual car race. Users are also enabled to trade virtual equipment, modify original configurations, etc.

Standalone, specialized video gaming platforms, such as Sony PlayStation, Microsoft XBOX, Nintendo GameCube, are also known. In December of 2001, Microsoft Corp. announced that it was on track to ship 1,000,000 devices until the end of the year. Microsoft also announced plans to provide networking capabilities for the device some time in 2002 (see http://news.cnet.com/news/0-1006-200-8161627.html).

Playing electronic games successfully, whether against the computer or human opponents, involves diverse skills, e.g., motor skills, strategy skills, virtual equipment design, and requires innovation with regard to many aspects of a given virtual environment. Innovative approaches, e.g., strategies, are distributed via on-line publications, software patches, cheats and other means. A successful strategy or a combination of game tools, e.g., “magic spells”, may provide a player or a team with a significant advantage over their opponents. On the other hand, when the novel advancement is revealed, e.g., through a game against the opponent, nothing prevents other gamers to repeat the innovation without any compensation to the innovator. Therefore an incentive is created for withholding new ideas, thus limiting development of the game. Henceforth, a condition exists that prevents less advanced users from moving further within the game, which in turn may lead to frustration and limited participation in the activity. As discussed above, user participation is of a major economic value to game portal operators, game developers and distributors, and eventually to the gamers community.

Accordingly, a need exists for an efficient system for encouraging, protecting and distributing novel approaches, e.g., within a particular game context, especially in a network environment.

The inventor has noticed a parallel between the above scenario and the laws on intellectual property rights (IPR), which have been called into being in order to stimulate progress in the useful arts. Consider the U.S. Patent and Trademark Office (USPTO), whose basic role over 200 years has been to promote the progress of science and the useful arts by securing for limited times to inventors the exclusive right to their respective discoveries (Article 1, Section 8 of the United States Constitution). Similar national and supra-national organizations and arrangements exist all over the globe.

Direct application of traditional intellectual property rights in an environment created around an electronic game has some serious limitations. One is the length and the cost of the process to secure one's right to an invention. That is, it usually takes several years to obtain a patent, while the lifespan of a popular electronic game is much shorter. Also, patent applications are prepared and prosecuted by professionals, who possess the necessary technical, linguistic as well as legal skills.

Another set of problems relates to criteria currently applied to establishing the novelty of an idea. The parties involved have to conduct extensive searches among millions of documents, e.g., in order to identify proper prior art. Evolving technical fields, term definitions, semantic differences, drawing interpretation, etc., complicate the searches. In another aspect, important criteria such as “obviousness”, and “person skilled in the art” are open to interpretation and different interpretations emerge over time and in different jurisdictions.

Yet another group of problems relates to the enforcement and licensing of IPR. Patent infringement detection is a challenging task, especially in newer technology fields, such as software and semiconductors. The process involves teams of engineers as well as legal experts and has proved to be prone to prolonged litigation. IPR licensing is also time and resource consuming.

The inventor has realized that the aforementioned shortcomings and others can be overcome within an online innovation generation environment, e.g., a networked electronic game, virtual game processes on a server, a network of PCs, etc. The environment is made transparent in order to set and enforce rules related to innovation creation, distribution and usage. The environment enables monitoring of activities on at least one innovation station, e.g., a video game console, detection of a technique that enhances the performance of a user in a measurable manner, comparing the technique with a reference set, and registering the technique.

Creation of a new technique may be rewarded in accordance with the rules of the environment.

Consider, for example, a motorcycle race video game wherein a user is required to complete a certain number of laps on a virtual racetrack. The faster the user completes the task the more points he gets. The racetrack has a number of turns that allow for different traversing strategies under different (virtual) weather circumstances (wind, rain, dirt, etc.). Each strategy and/or a combination of such strategies result in a certain number of points, i.e., a measurable indicator of the strategy's efficiency. The game console or a third party on the network is enabled to monitor the user's actions and detect new strategies that consistently result in a higher score. When a new strategy is detected, it is registered, e.g., in a database. The novelty is established, e.g., at the time of the completion of the technique with a high score. The registration is done, e.g., by the monitoring system or at the user's request, e.g., when the user activates a designated hardware or software control (“Claim” button). The user is enabled to set up automatic tracking of the game, e.g., by entering into a service agreement with the monitoring system. The monitoring system notifies the user when a novel technique is detected.

Other examples of an innovative technique are troop formations for a battle, design of virtual apparatus or organism, such as motorcycle, car, game specie, a combination of defensive and attacking means, such as spells, shields, swords, etc.

In order to facilitate innovation monitoring and detection the environment can be further divided into segments, e.g., battlegrounds, racetrack segments, tournaments or other events, etc.

Furthermore, the user is enabled to claim a new technique as a “patent”, thus being able to exclude other users from using the technique. Accordingly, an incentive is created for potential participants to become a member of a new environment sooner rather than later.

Exclusion from a new technique can be conditionally lifted, e.g., when the innovator is provided with a certain amount of points, or for the duration of a training session, or in accordance with other rules and conditions of the game or community. A variety of IPR licensing models can be developed in such an environment in order to stimulate creation of an evolving social interaction between participants. In one example, an IPR free zone is established to promote learning. In another example, the innovator is enabled to freely share IPR with his/her team, while requiring a licensed use from an opposing team member.

The monitoring system enables detection of use of a registered technique and enforcement of licensing rules defined for the environment. In one example, enforcement is automatic, that is, every time a participant uses the technique he/she is charged a pre-defined number of points. In another example, enforcement is limited to competitive situations, such as tournaments, battles, etc, wherein competitors are required to license the opposing party's IPR. In yet another example, enforcement is limited to participants above a certain skill level. In one more example, a game developer designates specific segments of the environment for IPR enforcement.

Accordingly, an embodiment of the invention relates to a method of providing a virtual environment. The method comprises enabling to detect an innovative aspect in an interaction of a user with the environment; enabling to register information about the innovative aspect; and enabling the user to benefit from the registering of the information. As to the benefiting, this includes, e.g., providing the user with an advantage in the environment, a monetary award, or making the information about the innovation and the name of the inventor available to other users. The user may be allowed to claim an exclusive right to the innovative aspect with respect to other users in the environment, similar to, e.g., intellectual property rights such as patents. The registered information about the innovative aspect can be made conditionally available to one or more other users in the environment, e.g., determined by the inventor, depending on an elapse of a certain time period, depending on a location of an area in the virtual environment, depending on the willingness of other users to pay for the information in terms of genuine money or of handicap points in a game environment, etc.

Another embodiment relates to software for use with a virtual environment to enable to detect an innovative aspect in user interaction of one or more players with the environment. The software and/or hardware can be for the use of a specific player so as to be able to analyze several strategies based on data logged during his own sessions. The software can also be used to monitor multiple players to detect the best performer and to give an indication why this performer was the best. The software is typically specific to the environment. Similarly, yet another embodiment of the invention relates to an interactive software application, e.g., a video game, for enabling a user to interact with a virtual environment. The application includes a software component to enable to detect an innovative aspect in user interaction with the environment.

Consider, as an example, a strategy game, wherein a player guides his/her character through a labyrinth inhabited by unfriendly creatures. The character has attacking and protective attributes, which enable it to defeat the creatures. Certain combinations of attributes and/or the sequence of their use may prove to be more efficient against a particular set of unfriendly creatures assigned to a certain corridor of the labyrinth. The success of the user strategy can be easily established by, e.g., registering the number of unfriendly creatures that this user has rendered harmless and/or passing the corridor by the user's character. In order to claim a novel strategy, the user has, for example, to register his character's attributes before entering the corridor. This can be done automatically or under a certain condition, e.g., user action, game license, etc. After successful completion of the battle, the aforementioned attribute set may be registered with a virtual IPR authority by communicating the attributes to a remote computer. The timing of the claim to a new strategy or tactic can be established according to the rules of the virtual IPR system, e.g., upon successful completion of the battle, or upon submitting a log of the episode, etc. Additional requirements toward the user's gaming device, such as hardware/software integrity, use of certified accessories, and others, may be introduced to ensure novelty verification. A person ordinary skilled in the art would appreciate that a wide variety of strategy confirmation and implementation methods are available in an electronic gaming environment. For example, a graphic simulation of the claimed episode can be presented to demonstrate an implementation of the claimed strategy. The simulation may be created by recording signals or data from the user's input/output devices, such as keypad, monitor, feedback sensors, along with the portion of game software, e.g., assembly instructions and memory states, executed during the episode.

In another example, consider a game wherein the player controls a group of characters, e.g., battle groups, fortresses, etc., each or a combination of which having a set of attacking and defensive attributes. A person skilled in the art will appreciate that implementation of such a game will be substantially equivalent with the aforementioned example of the strategy game. For example, the combined attributes of all the characters can be assigned to, e.g., a software object, substantially equivalent to a character of a higher order described above.

In yet another example, consider a motorcycle racing game, wherein the user is required to drive a virtual device on a simulated racetrack. In one implementation, in order to claim IPR on traversing a particular turn, the user is required to identify the intended trajectory, which he intends to claim. The user is enabled to record and subsequently claim the trajectory, if he guides his virtual motorcycle using the designated trajectory and achieves a better result, e.g., shorter time, than other players, traversing the same turn. The time of each player is communicated to the server and is compared to existing records. The time differential, e.g., 1 sec. or 0.5 sec., necessary for a successful claim can be set up by the system, depending on the required skill level, complexity of the track configuration and other factors.

In another implementation, for lower skill levels, the user is not required to identify the intended trajectory before the race. The trajectory and speed combination is recorded automatically and claimed when a new best result is achieved.

Another embodiment of the invention relates to a database for use with a virtual environment. The database is the repository for information about respective innovative aspects of interactions of respective users with the environment. The database could be made conditionally accessible or available to the community of users.

### BRIEF DESCRIPTION OF THE DRAWING

The invention is explained in more detail, by way of example, with reference to the accompanying drawing, wherein:

FIG. 1 is a diagram of an innovation monitoring system; and

FIG. 2 is a diagram illustrating a game console.

### DETAILED EMBODIMENTS

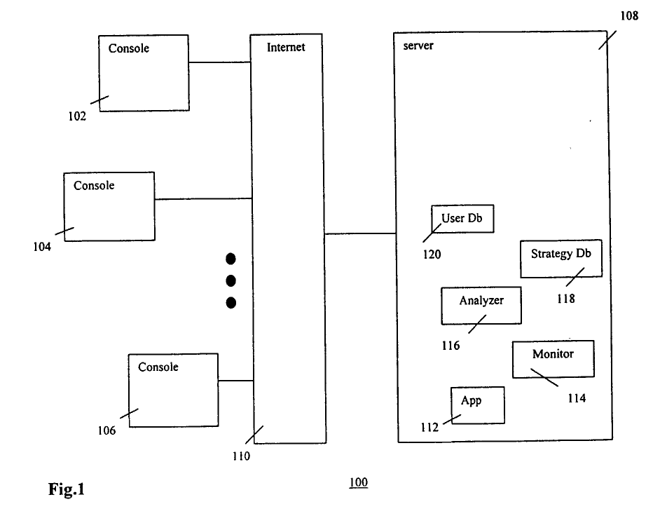

FIG. 1 is a diagram of an innovation monitoring system in a client-server environment 100. Environment 100 comprises game consoles 102, 104, . . . , 106 that are coupled to a server 108 via the Internet or another data network 110. Server 108 runs a multi-user interactive application 112, e.g., a game, through which the users or participants at consoles 102-106 can interact with each other and with a virtual environment. Respective parts of application 112 may be stored locally at one or more of consoles 102-106.

Server 108 has a monitoring service 114 that monitors the progress or score history of each of the participants at consoles 102-106. For example, monitor 114 keeps track of how quickly or well a participant performs a task in the virtual environment, the manner wherein the participant performs the task in terms of, e.g., a history log of data representative of the user input at the relevant console and the state of the game, etc.

Assume that during a session of game 112 a specific participant, e.g., the one at console 102, performs significantly better at a specific stage of the game than the ones at consoles 104-106. An analyzer 116 then compares the stored input data and state data for this participant and for this stage with corresponding data relevant to the other participants in order to determine why the participant at console 102 performed significantly better than the others. Analyzer 116 comprises, e.g., software, such as an expert system, or is a human agent or involves both. If analyzer 116 finds a qualitative reason or other strategy explaining the significantly better performance, the finding is compared to strategies stored previously in a database 118. The comparing may be done by software, by a human operator or by both, depending on the complexity of the game and/or the resources available.

If database 118 does not comprise the currently found strategy, the latter is stored in database 118 for future reference, together with the name or nickname of the participant at console 102 who invented this strategy first. User identification and/or registration may be provided by a network-based service, e.g., Microsoft Passport, AOL instant messenger, and others. Accordingly, strategies developed during the operational use of game 112 get registered, and can be made accessible to the gamers community, e.g., so as to allow them to prepare for or continue the session. Preferably, the name of the person who invented this strategy is published as well. This contributes to this person's reputation and status in the community, which is a reward in its own. This publication also motivates other ambitious players to invent even better strategies so as to get their names published, thus acquiring status and esteem.

If a same or similar strategy is already stored in database 118, the participant at console 102 is listed in a database 120 as having used a strategy listed as invented by another participant. The use of a registered strategy by another can now be made beneficial to its inventor, e.g., by giving the inventor bonus points in his next or current session(s), by giving the relevant user a handicap in the next or current session(s), or by otherwise modifying or adapting the rules of the game for the user and/or inventor. Alternative compensation procedures can be implemented, e.g., a monetary reward to the inventor in terms of a royalty on a per-use basis (e.g., one cent), charged to the account of the user, or a monetary award supplied by the service provider as a token of appreciation that the game now is made more interesting, etc.

Environment 100 can be configured in a variety of manners. For example, the monitoring, analyzing and registering can be delegated to a service different from the one that is providing the game. Alternatively, the functionalities of the game, the monitoring thereof, etc., as described can be distributed among various components and/or parties including one or more of consoles 102-106 (or PCs, thin clients, etc) and/or the participants themselves. As to the latter, a person who has analyzed the data representing the history of the game and who has discovered a new strategy implemented by another who is unaware of its novelty could be made the beneficiary of this discovery, that otherwise would have gone unnoticed. Again, this stimulates people to really dig into the innards of the game so as to improve and extend its potential, and to stimulate people getting immersed in the game at the strategic and tactical levels.

In an alternative implementation (not shown), consoles 102-106 each have a local monitoring system that communicates with a local or a remote analyzer and strategy database. This implementation allows the user to study, and to keep track of his/her own game performance. The performance is then represented by the new strategies and tactics that this user has developed him/herself. A local repository then provides the history in terms of game interactions that are better than others.

In an embodiment of the invention, the participants may operate in a virtual environment that has zones wherein the use of a strategy or tactic registered by another may lead to extra handicaps or royalties, and other zones wherein that use is free.

In another embodiment of the invention, the user may actively and directly register his/her novelty with database 118 as if it were going to be patented. For example, in a race game, the user builds from standard, or newly to be designed, virtual components his/her own virtual vehicle. The personal vehicle is then one that he/she believes is the best match for the conditions that are expected to occur in the race later on. The configuration of the self-designed vehicle is personalized by selecting, e.g., the geometry of the chassis, location of the wheels, the size and weight and distribution of the drive train, the size and location of the fuel tank, the type of tires, the type and number of spare parts and tools to be taken along, etc. The user then can register his/her original design or parts thereof if it performs significantly better so as to benefit from his/her contribution to the virtual art. Of course, this can be a team effort, of the designer of the vehicle and of the driver.

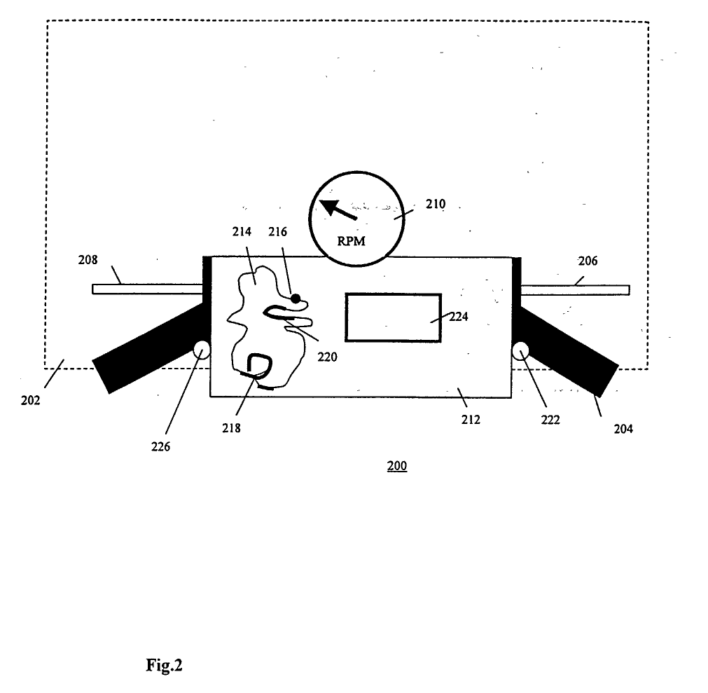

FIG. 2 is a diagram illustrating a console 200 for a virtual motorcycle race wherein the user sees the virtual environment projected onto a large display monitor 202 in front of console 200 as if he/she were riding along the track. Console 200 comprises the controls for the virtual motorcycle, e.g., the handlebars with a throttle 204 to control the acceleration, a front wheel brake lever 206, a clutch lever 208 for changing gears, a rev counter 210, etc. The gear shift pedal and rear wheel brake pedal are not shown in the diagram. A front panel comprises a display monitor 212 to provide extra information to the user. In the example shown, monitor 212 shows an image 214 of the track. Image 214 has an indicium 216 that represents the user's current location along the track. Image 214 also has highlighted segments 218 and 220. The highlighting indicates that “patented” strategies are available to the user for negotiating these stretches in the currently fastest way. In the race, the user may select to adopt a patented strategy for negotiating such a stretch. Selection is done, for example, by pushing button 222 before entering highlighted segment 218 or 220. The selection activates the auto-pilot to guide the virtual motorcycle through the selected segment. At the end of the segment, the auto-pilot returns control to the user. In return for using the patented strategy, the user may have, for example, to return bonus points accumulated over time, pay a royalty, or adopt a handicap for the rest of the race, etc. Monitor 212 may indicate, e.g., in a window 224, the penalty or compensation that the user is to pay per segment for use of the patented strategy covering that segment.

If the user believes he/she is capable of negotiating a stretch of the track better than most others, he/she may want to claim the manner wherein he/she negotiates the stretch. This may be done before entering the stretch, e.g., by pressing “claim”-button 226, or afterwards, when the user has analyzed his/her performance and possibly that of others. If the claim is valid, i.e., the user has indeed found a way of traversing the stretch better than the others or better than is known in database 118, he/she can make this method of traversing available to others. If the user's belief of being better was in vain, bonus points may be subtracted from the user's score, or a compensation fee may be charged to the user's account.

What is claimed is:

1. A method of providing a virtual environment, the method comprising:
enabling to detect an innovative aspect in an interaction of a user with the environment;
enabling to register information about the innovative aspect; and
enabling the user to benefit from the registering of the information.

2. The method of claim 1, wherein the enabling to benefit comprises providing the user with an advantage in the environment.

3. The method of claim 1, wherein the enabling to benefit comprises providing the user with a monetary award.

4. The method of claim 1, wherein the enabling to benefit comprises making the information and a name of the user available to other users.

5. The method of claim 1, comprising enabling the user to claim an exclusive right to the innovative aspect with respect to other users in the environment.

6. The method of claim 1, comprising making the registered information about the innovative aspect conditionally available to one or more other users in the environment.

7. The method of claim 1, wherein the environment is associated with an electronic game.

8. Software for use with a virtual environment to enable to detect an innovative aspect in user interaction with the environment.

9. A database for use with a virtual environment, the database being a repository for information about respective innovative aspects of interactions of respective users with the environment.

10. An interactive software application for enabling a user to interact with a virtual environment and including a software component to enable to detect an innovative aspect in user interaction with the environment.
